(19) United States
(12) Patent Application Publication
(10) Pub. No.: US 2026/0356269 A1
(43) Pub. Date: Nov. 12, 2026

(54) ARTICLE HOLDING DEVICE

(71) Applicant: NIFCO INC., Yokosuka-shi, Kanagawa (JP)

(72) Inventor: Toshiaki SOMA, Yokosuka-shi, Kanagawa (JP)

(21) Appl. No.: 19/139,372

(22) PCT Filed: Jan. 24, 2024
(86) PCT No.: PCT/JP2024/001971

§ 371 Date: Jun. 16, 2025

(30) Foreign Application Priority Data
Jan. 31, 2023 (JP) 2023-012508

(51) Int. Cl. B60N 3/10; F16M 11/04; F16M 11/22

(52) U.S. Cl. CPC B60N 3/106; F16M 11/041; F16M 11/22

(57) ABSTRACT

One of a holder and an arm includes a shaft, and the other of the holder and the arm includes a guide. The guide includes an actuating portion and a mounting portion. The arm advances and retreats when the shaft moves relative to the actuating portion along the actuating portion. The mounting portion is used to insert the shaft into the guide. After the shaft moves along the mounting portion, the shaft moves so as to bend toward the actuating portion.

### FIELD

The present disclosure relates to an article holding device that holds articles such as bottles and cups.

### BACKGROUND

Patent Literature 1 discloses a cup holder that is an example of the article holding device. The cup holder includes a base and an arm connected to the base with a coil spring interposed therebetween. The arm retracts into and protrudes from the base through an opening formed in the base.

The base has a left side wall and a right side wall each having a guide groove formed therein. The opening mentioned above is located between the left and right side walls. The guide grooves in the base extend diagonally downward so as to be more away from the opening as the locations thereof are closer to the bottom of the base.

The arm has a left side wall and a right side wall. Each of the left and right side walls of the arm includes a shaft fitted into a corresponding one of the guide grooves. The shafts that move along the guide grooves (i) retract the arm from the opening in the base and (ii) protrude the arm from the opening in the base.

The coil spring urges the arm to protrude from the opening in the base. When a cup is placed in the cup holder, the pressure of the cup retracts the arm from the opening against the urging force of the coil spring. When the cup is taken out of the cup holder, the urging force of the coil spring pushes the arm out of the opening.

### Citation List

### Patent Literature

Patent Literature 1: Japanese Patent Application Laid-open Publication No. 2010-241181

### SUMMARY OF THE INVENTION

### Technical Problem

As described above, the movements of the two shafts along the two guide grooves (i) protrude the arm out of the opening and (ii) retract the arm from the opening. However, to mount the two shafts in the two guide grooves, the distance between the two guide grooves is required to be once pushed to be widened by fingers or other implements. Larger lengths of the two shafts restrain the shafts from coming out of the guide grooves, but require the distances between the two guide grooves to be pushed to be more widened. For this reason, the article holding device described above is desired to be capable of reducing the load to mount the shafts to the guide grooves while restraining the shafts from coming out.

### Solution to Problem

According to one aspect of the present disclosure, an article holding device is provided, wherein the article holding device includes a holder including a housing configured to accommodate an article and an arm configured to enter the housing so as to hold the article and to exit the housing, in which one of the holder and the arm includes a shaft; the other of the holder and the arm includes a guide; the guide includes an actuating portion and a mounting portion that continues to the actuating portion and is bent toward the actuating portion; the arm enters the housing or exits the housing when the shaft moves relative to the actuating portion along the actuating portion; and the shaft moves so as to bend toward the actuating portion after moving along the mounting portion so as to be received by the actuating portion from the mounting portion.

According to one aspect of the present disclosure, an article holding device is provided, wherein the article holding device includes a holder including a housing configured to accommodate an article, an arm configured to enter the housing so as to hold the article and to exit the housing, and an urging unit configured to urge the arm to enter the housing, in which one of the holder and the arm includes a shaft; the other of the holder and the arm includes a guide; the guide includes an opening that receives the shaft; the arm enters the housing or exits the housing when the shaft moves relative to the guide along the guide; one of the holder and the arm is an abutment member; the abutment member includes a limiter; the limiter is located on a path of a movement of the urging unit relative to the abutment member; and the limiter is configured to restrict a displacement of the shaft moving out of the opening by contacting the urging unit even if the urging unit is displaced with respect to the abutment member.

### BRIEF DESCRIPTION OF DRAWINGS

FIG. 1 is a perspective view illustrating a configuration of an article holding device.

FIG. 2 is a sectional view illustrating the configuration of the article holding device.

FIG. 3 is a perspective view illustrating a configuration of an arm.

FIG. 4 is an operation diagram illustrating how to mount a shaft to a guide.

FIG. 5 is a sectional view illustrating the arm that has entered a housing.

FIG. 6 is a sectional view illustrating the arm that has exited the housing.

FIG. 7 is a plan view illustrating the arm according to a modification of the embodiment of the present disclosure.

FIG. 8 is a sectional view illustrating the arm of the modification.

FIG. 9 is a sectional view illustrating the arm of the modification that has entered the housing.

FIG. 10 is a sectional view illustrating the arm of the modification that has exited the housing.

FIG. 11 is a perspective view illustrating the arm according to another modification of the embodiment.

FIG. 12 is a sectional view illustrating the article holding device of the other modification.

### DESCRIPTION OF EMBODIMENTS

### Article Holding Device 10

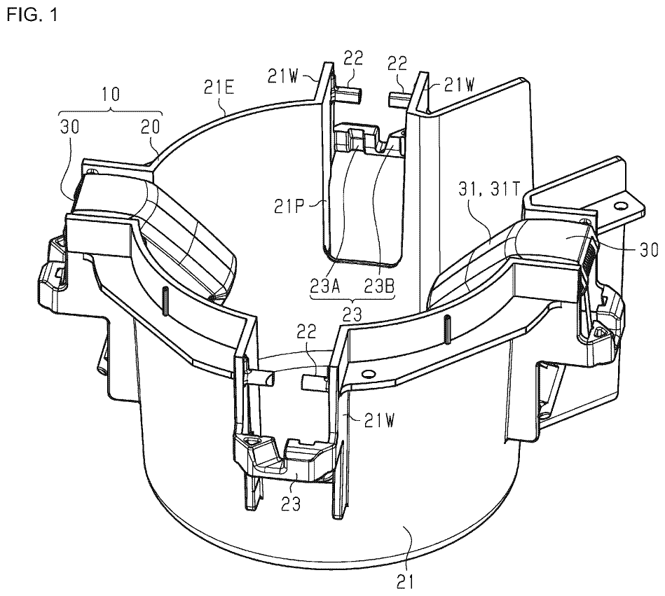

As illustrated in FIG. 1, an article holding device 10 includes a holder 20 and an arm 30. The holder 20 includes a housing 21, a shaft 22, and a joint 23. For convenience of explanation of the structure of the holder 20, FIG. 1 does not illustrate two of the four arms 30. Examples of articles held by the article holding device 10 include cups having a cylindrical or cylindrical base shape, or bottles having a cylindrical shape, a cylindrical base shape, or a cylindrical shape narrow in the middle.

### Holder 20

The housing 21 has a bottomed cylindrical shape extending in an upper-lower direction. The housing 21 has four openings 21P equally distributed in the peripheral direction of the housing 21. Each of the openings 21P extends downward from a top edge 21E of the housing 21. The opening 21P is sandwiched between two support walls 21W that protrude radially outward from the outer peripheral surface of the housing 21. The two support walls 21W have each a flat plate shape extending in the upper-lower direction and are arranged in a right-left direction. The shaft 22 and the joint 23 are formed integrally with the two support walls 21W.

The shaft 22 is provided one on each of the support walls 21W. The two shafts 22 are arranged on top of the support walls 21W so as to face each other with the opening 21P interposed therebetween. The shaft 22 integral with one of the support walls 21W extends toward the other of the support walls 21W. The two shafts 22 are arranged so as to face each other.

The joint 23 is provided one on each of the two support walls 21W. The joint 23 is located in the middle in the upper-lower direction of the support walls 21W. The joint 23 connects the two support walls 21W. One joint 23 includes one holder stop 23A and one first limiter 23B. The holder 20 including the first limiter 23B is an example of an abutment member.

The holder stop 23A faces the interior of the housing 21. The holder stop 23A has a groove shape extending in the upper-lower direction. The holder stop 23A has a shape that hooks a spring arm 42 of a torsion coil spring 40. The holder stop 23A and the first limiter 23B are arranged in the right-left direction in which the shaft 22 extends. The first limiter 23B has a groove shape extending in the upper-lower direction. The first limiter 23B has a shape to receive the spring arm 42 that rotates with the arm 30.

### Arm 30

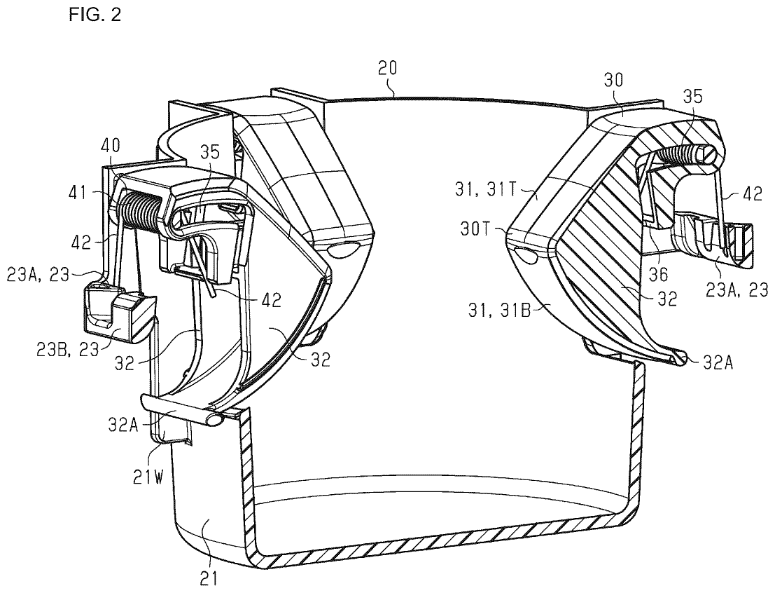

As illustrated in FIG. 2, the arm 30 includes a retaining wall 31 and two guide walls 32.

The retaining wall 31 has a beak shape that protrudes in the radial direction of the housing 21 toward the interior of the housing 21. The protruding end of the retaining wall 31 is an inner end 30T of the arm 30. The retaining wall 31 is located between the two support walls 21W. The retaining wall 31 has a first retaining slope 31T and a second retaining slope 31B. The first retaining slope 31T extends from the upper end of the opening 21P toward the inner lower side of the housing 21. The second retaining slope 31B extends from the lower end of the first retaining slope 31T to the lower end of the opening 21P.

The two guide walls 32 have each a flat plate shape that expands along the support walls 21W. The two guide walls 32 are arranged side by side in the right-left direction. The two guide walls 32 are integral with the retaining wall 31. The two guide walls 32 are arranged between the two support walls 21W. The two guide walls 32 face each other with the retaining wall 31 interposed therebetween.

The lower ends of the guide walls 32 are provided with a stopper 32A. The stopper 32A protrudes toward outsides of the support walls 21W. The stopper 32A abuts on outer end surfaces of the support walls 21W outside the housing 21, thereby restricting the lower end of the arm 30 from entering the interior of the housing 21.

### Guide

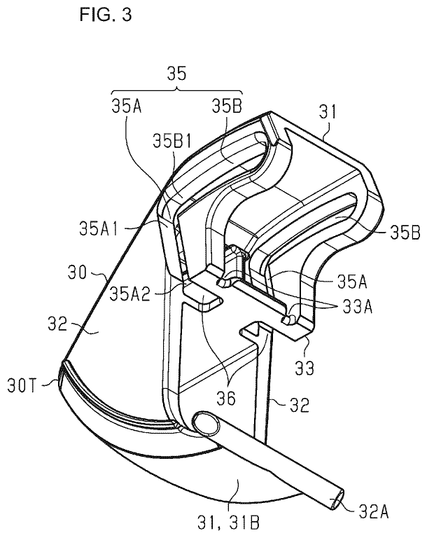

As illustrated in FIG. 3, the arm 30 includes a hooking wall 33. The hooking wall 33 has a flat plate shape extending from the inner end 30T toward the rear end of the arm 30. The hooking wall 33 is located in the middle in the upper-lower direction of the arm 30. The hooking wall 33 connects the two guide walls 32 between the two guide walls 32.

The rear end of the hooking wall 33 is provided with two arm stops 33A. The two arm stops 33A are recessed from the rear end toward the inner end 30T of the arm 30. The two arm stops 33A are arranged in the right-left direction.

Referring back to FIG. 2, the torsion coil spring 40 is an example of an urging unit. The torsion coil spring 40 is attached to the two shafts 22. The torsion coil spring 40 includes one coil 41 and two spring arms 42. In a direction in which the shafts 22 extend, the length of the coil 41 is larger than the sum of the lengths of the two shafts 22. The two shafts 22 are inserted into the coil 41 and also leave a gap therebetween in the coil 41 in the direction in which the shafts 22 extend. The two spring arms 42 extend in a tangential direction of the coil 41 from both ends in the axial direction of the coil 41. One of the spring arms 42 is hooked on the holder stop 23A. The other of the spring arms 42 is hooked on one of the arm stops 33A.

The torsion coil spring 40 urges the arm stops 33A against the holder stops 23A so as to widen an angle formed by the two spring arms 42 as viewed from the axial direction of the coil 41. The torsion coil spring 40 thereby urges the arm 30 so as to enter the housing 21.

Referring back to FIG. 3, the arm 30 includes one guide 35 on each of the guide walls 32. The guide 35 is a through-groove penetrating the guide wall 32. The guide 35 connects a space outside the arm 30 to a space interposed between the two guide walls 32. The groove width of the guide 35 is large enough for the shaft 22 to pass therethrough, and for the shaft 22 to move relative to the guide 35 in the extending direction of the guide 35.

The guide 35 has an inverted L-shape including an actuating portion 35B and a mounting portion 35A. The mounting portion 35A continues to the actuating portion 35B via a bend. The mounting portion 35A has a linear shape extending from the hooking wall 33 toward the inner upper side of the housing 21. The actuating portion 35B has a gentle arc shape. The actuating portion 35B extends along a front-back direction that is a direction from the rear end of the arm 30 toward the inner end 30T. The outer end in the actuating portion 35B is closed. The inner end in the actuating portion 35B is a connection 35B1 that continues to the mounting portion 35A.

The mounting portion 35A includes a first end 35A1 and a second end 35A2. The first end 35A1 of the mounting portion 35A continues to the connection 35B1 of the actuating portion 35B. The second end 35A2 opens downward. The hooking wall 33 has a through-groove continuing to the second end 35A2 of the mounting portion 35A. The second end 35A2 of the mounting portion 35A and the through-groove in the hooking wall 33 form an opening 36. The opening 36 extends along the extending direction of the shaft 22.

The opening 36 receives the shaft 22 into the guide 35. The mounting portion 35A guides the shaft 22 to the actuating portion 35B through a relative movement of the shaft 22 along the mounting portion 35A. The mounting portion 35A continues to the actuating portion 35B so that the movement of the shaft 22 along the mounting potion 35A is curved toward the actuating portion 35B. The actuating portion 35B receives the shaft 22 from the connection 35B1. The actuating portion 35B causes the housing 21 to advances to and retreats from the arm 30 through relative movements of the shaft 22 along the actuating portion 35B.

### Mounting Operation

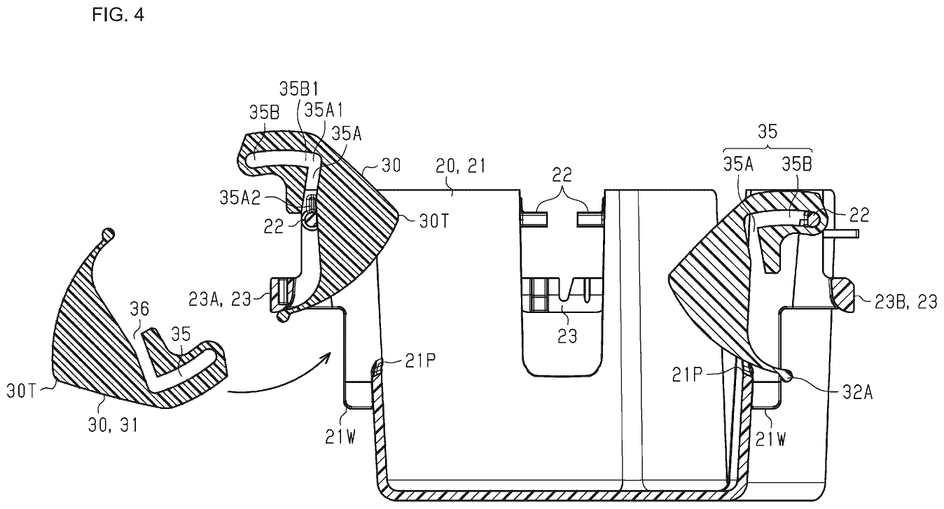

As illustrated on the lower left side of FIG. 4, in a mounting operation to mount the arm 30 to the holder 20, the arm 30 is first placed in a posture inverted front side back and upside down, and the guide 35 and the inner end 30T of the retaining wall 31 are inserted from below the joint 23 toward the opening 21P.

Then, as illustrated on the upper left side of FIG. 4, the arm 30 is placed in a posture aligned with the normal posture in the front back direction and the upper-lower direction, and the opening 36 of the arm 30 is placed above the shaft 22. Then, after receiving the shaft 22 into the opening 36 of the arm 30, the shaft 22 is moved relative to the mounting portion 35A along the mounting portion 35A from the second end 35A2 to the first end 35A1 of the mounting portion 35A. The shaft 22 is then moved relative to the actuating portion 35B along the actuating portion 35B from the connection 35B1 of the actuating portion 35B to the outer end in the actuating portion 35B.

As a result, as illustrated on the right side of FIG. 4, the shaft 22 is located in the actuating portion 35B while the stopper 32A is located outside the support wall 21W and the arm 30 is located inside the joint 23.

Then, from the state where the shaft 22 is located in the actuating portion 35B, the two shafts 22 are mounted in the coil 41 of the torsion coil spring 40. At this time, one of the spring arms 42 is hooked on the holder stop 23A, and the other of the spring arms 42 is hooked on one of the arm stops 33A.

As a result, the arm stops 33A are urged toward the inside of the housing 21 against the holder stops 23A so that the arm 30 advances into the housing 21. The shaft 22 is urged in the actuating portion 35B toward the outer end in the actuating portion 35B, that is, the shaft 22 is urged in the actuating portion 35B so as to be away from the connection 35B1 of the actuating portion 35B.

### Operation

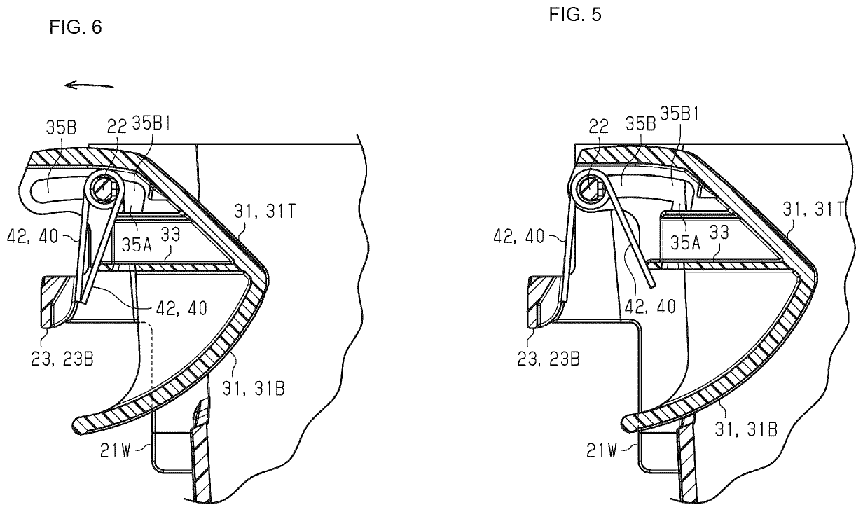

As illustrated in FIG. 2, one of the two spring arms 42 continuing to the coil 41 is hooked on the holder stop 23A. As illustrated in FIG. 5, the other of the two spring arms 42 is hooked on the hooking wall 33. When no external force acts on the arm 30, the urging force of the torsion coil spring 40 locates the first retaining slope 31T and the second retaining slope 31B in the housing 21. The urging force of the torsion coil spring 40 makes the shaft 22 away from the connection 35B1 of the actuating portion 35B and presses the shaft 22 against the outer end in the actuating portion 35B.

When an article starts to be accommodated, a pressing force to push down the arm 30 starts acting on the first retaining slope 31T from the article. The downward pressing force acting on the first retaining slope 31T moves the article down along the first retaining slope 31T relative to the first retaining slope 31T.

At this time, the movement of the actuating portion 35B relative to the shaft 22 is restricted in the upper-lower direction. The movement of the actuating portion 35B relative to the shaft 22 is limited to (a) a counterclockwise rotation about the shaft 22 and (b) a movement along the actuating portion 35B that brings the connection 35B1 closer to the shaft 22. The urging force of the torsion coil spring 40 restrains (a) the rotation of the actuating portion 35B and (b) the movement of the shaft 22 along the actuating portion 35B. Therefore, when the downward pressing force acting on the first retaining slope 31T exceeds the urging force of the torsion coil spring 40, (a) the actuating portion 35B rotates counterclockwise, or (b) the shaft 22 comes closer to the connection 35B1. This operation causes the arm 30 to exit the housing 21.

When the article starts to be taken out, a pressing force to push up the arm 30 acts on the second retaining slope 31B from the article. The upward pressing force acting on the second retaining slope 31B causes the article to move upward along the second retaining slope 31B relative to the second retaining slope 31B.

At this time, the movement of the actuating portion 35B relative to the shaft 22 is restricted in the upper-lower direction. The movement of the actuating portion 35B relative to the shaft 22 is limited to (a) a clockwise rotation about the shaft 22 and (b) the movement along the actuating portion 35B that brings the connection 35B1 closer to the shaft 22. The urging force of the torsion coil spring 40 restrains (a) the rotation of the actuating portion 35B and (b) the movement of the shaft 22 along the actuating portion 35B. Therefore, when the upward pressing force acting on the second retaining slope 31B exceeds the urging force of the torsion coil spring 40, (a) the actuating portion 35B rotates clockwise, or (b) the shaft 22 comes closer to the connection 35B1. This operation causes the arm 30 to exit the housing 21.

If the article has a larger coefficient of friction against the retaining wall 31, the pressing force acting on the retaining wall 31 from the article is more easily converted into (a) the rotation of the actuating portion 35B. If the article has a smaller coefficient of friction against the retaining wall 31, the pressing force acting on the retaining wall 31 from the article is more easily converted into (b) the movement of the shaft 22 along the actuating portion 35B.

As described above, (b) the movement of the shaft 22 along the actuating portion 35B is accompanied by the movement of the spring arm 42 by the hooking wall 33 against the urging force of the torsion coil spring 40. In addition, (b) the movement of the shaft 22 along the actuating portion 35B brings the shaft 22 closer to the connection 35B1. If the article has a larger coefficient of friction against the retaining wall 31, the pressing force acting on the retaining wall 31 from the article is more easily converted into (b) the movement of the shaft 22 along the actuating portion 35B, thereby more easily bringing the shaft 22 closer to the connection 35B1.

As illustrated in FIG. 6, the holder 20 includes the first limiter 23B of the joint 23 on a path of the spring arm 42 that moves relative to the shaft 22. Therefore, the spring arm 42 is allowed to be moved by the hooking wall 33 until the spring arm 42 contacts the first limiter 23B. The movement of the spring arm 42 by the hooking wall 33 is stopped by the contact of the spring arm 42 with the first limiter 23B. Thus, (b) the movement of the shaft 22 along the actuating portion 35B is stopped before the shaft 22 reaches the connection 35B1.

### Effects

According to the embodiment described above, effects listed below are obtained.

(1) In the mounting operation, the shaft 22 received by the mounting portion 35A moves along the mounting portion 35A and introduced to the actuating portion 35B continuing to the mounting portion 35A. The movement of the shaft 22 along the mounting portion 35A bends toward the actuating portion 35B. Therefore, a load that deforms the actuating portion 35B when the shaft 22 is mounted onto the guide 35 can be reduced while restraining the shaft 22 from coming out of the actuating portion 35B.

(2) In the mounting operation, the shaft 22 received by the guide 35 is introduced from the opening 36 through the mounting portion 35A to the actuating portion 35B. The opening 36 includes the second end 35A2 of the mounting portion 35A. This configuration facilitates a worker to intuitively understand a work method for mounting the shaft 22 onto the guide 35.

(3) The arm 30 is urged by the torsion coil spring 40 so that the arm 30 enters the housing 21. Thus, the arm 30 holds the article suitably for the size and shape thereof.

(4) Since the shaft 22 has both the function to guide the advance and retreat of the arm 30 and the function to support the torsion coil spring 40, the number of components in the holder 20 can also be reduced.

(5) Since the movement of the spring arm 42 is restricted by the first limiter 23B, the movement of the shaft 22 relative to the actuating portion 35B is restrained within a predetermined range. The fact that the movement of the shaft 22 relative to the actuating portion 35B is restrained within the predetermined range stabilizes the movable range of the arm 30 relative to the holder 20.

(6) In particular, since the movement of the shaft 22 relative to the actuating portion 35B is restrained within the predetermined range not including the connection 35B1, the shaft 22 that has been introduced to the actuating portion 35B from the mounting portion 35A is difficult to return to the mounting portion 35A. This fact increases the repeatability of the relative movement of the shaft 22 along the actuating portion 35B.

The embodiment described above can also be implemented with the following modifications.

### First Modification: Limiter

The first limiter 23B may be located so as to contact the spring arm 42 when the shaft 22 is located midway in the actuating portion 35B in the extending direction of the actuating portion 35B. For example, the first limiter 23B may be located more inside the housing 21 than the holder stop 23A.

### Second Modification

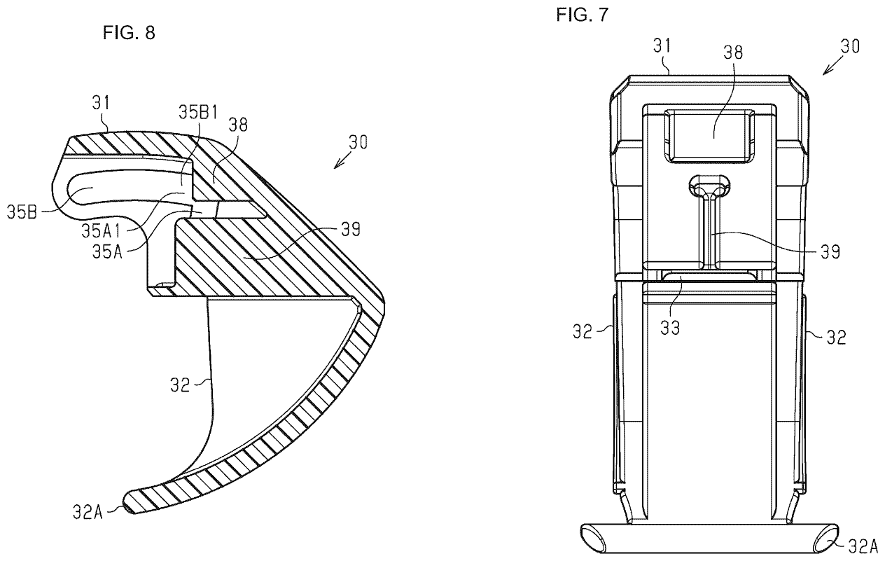

The arm 30 may include an upper limiter 38 and a lower limiter 39, as illustrated in FIG. 7. The upper and the lower limiters 38 and 39 are examples of a second limiter. The upper limiter 38 and the lower limiter 39 are ribs integral with an outer surface of the retaining wall 31. The upper limiter 38 is located above the lower limiter 39. The upper limiter 38 reinforces an upper portion of the retaining wall 31. The lower limiter 39 is integral with the hooking wall 33. The lower limiter 39 reinforces the hooking wall 33.

The upper limiter 38 and the lower limiter 39 are located away from and between the two guide walls 32. The upper limiter 38 and the lower limiter 39 are away from the guide wall 32 by the length of the shaft 22 in the extending direction of the shaft 22. In other words, a gap in the extending direction of the shaft 22 is left between the upper limiter 38 and the guide wall 32 by a size large enough to allow the shaft 22 to pass through. The gap in the extending direction of the shaft 22 is left between the upper limiter 38 and the guide wall 32 by a size large enough to allow the shaft 22 to pass through. This configuration allows the upper limiter 38 and the lower limiter 39 to receive the shaft 22 in the guide 35.

As illustrated in FIG. 8, the upper limiter 38 overlaps the connection 35B1 of the actuating portion 35B when viewed from a viewpoint facing the guide wall 32. The lower limiter 39 overlaps the mounting portion 35A when viewed from the viewpoint facing the guide wall 32.

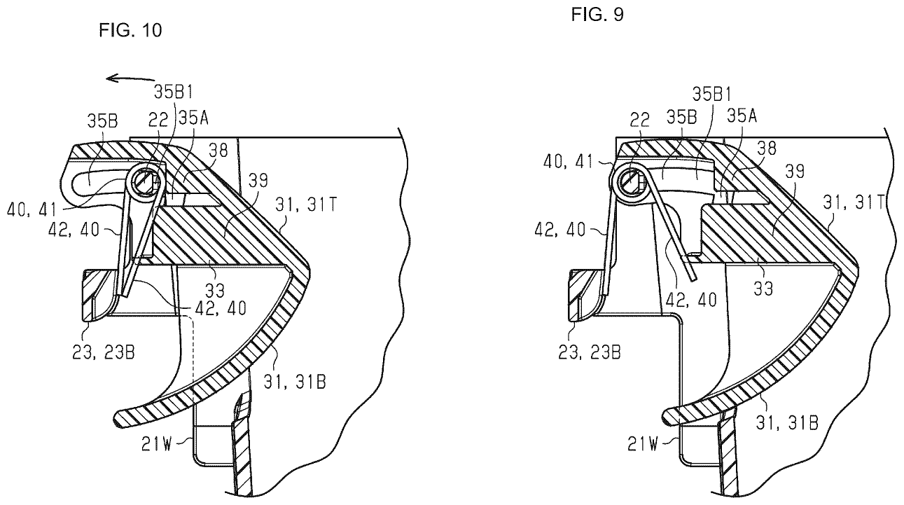

As illustrated in FIG. 9, the upper limiter 38 is located so as to restrict the coil 41 of the torsion coil spring 40 from passing through the connection 35B1 when viewed from the viewpoint facing the guide wall 32. The lower limiter 39 is located so as to restrict the coil 41 of the torsion coil spring 40 from moving from the actuating portion 35B to the mounting portion 35A when viewed from the viewpoint facing the guide wall 32.

As illustrated in FIG. 10, (b) the movement of the shaft 22 along the actuating portion 35B is accompanied by bringing the shaft 22 closer to the connection 35B1 and bringing the coil 41 closer to the connection 35B1. In this regard, the arm 30 is provided with the upper limiter 38 on a path of the coil 41 that moves relative to the arm 30. Therefore, (b) the movement of the shaft 22 along the actuating portion 35B is allowed until the coil 41 contacts the upper limiter 38. Then, (b) the movement of the shaft 22 along the actuating portion 35B is restrained by contact of the coil 41 with the upper limiter 38.

Even if the arm 30 further receives the pressing force so that the coil 41 returns to the mounting portion 35A beyond the upper limiter 38, (b) the movement of the shaft 22 along the actuating portion 35B is restrained by contact of the coil 41 with the lower limiter 39.

According to the second modification described above, effects listed below are obtained.

(7) The movement of the coil 41 is restricted by the upper limiter 38 and the lower limiter 39. Therefore, the movement of the shaft 22 relative to the guide 35 is restrained within a predetermined range. The fact that the movement of the shaft 22 relative to the guide 35 is restrained within the predetermined range stabilizes the movable range of the arm 30 relative to the holder 20.

(8) In particular, since the movement of the shaft 22 relative to the actuating portion 35B is restrained within the predetermined range not including the connection 35B1, the shaft 22 that has been introduced to the actuating portion 35B from the mounting portion 35A is difficult to return to the mounting portion 35A. Furthermore, even if the shaft 22 returns from the actuating portion 35B to the mounting portion 35A, the shaft 22 is difficult to return to the opening 36. This fact further restrains the arm 30 from departing from the holder 20.

### Third Modification

The article holding device 10 may exclude at least one of the first limiter 23B, the upper limiter 38, and the lower limiter 39.

### Fourth Modification

If the article holding device 10 includes at least one of the first limiter 23B, the upper limiter 38, and the lower limiter 39, the bend formed at the boundary between the mounting portion 35A and the actuating portion 35B may be excluded from the guide 35.

According to the fourth modification described above, effects similar to (5) to (8) described above are obtained even if (1) described above due to the bending of the movement of the shaft 22 along the mounting portion 35A toward the actuating portion 35B is not obtained.

### Fifth Modification: Shaft 22

The shaft 22 may be located at a lower portion in the upper-lower direction of the support wall 21W, and the guide 35 may be located at a lower portion in the upper-lower direction of the guide wall 32. The stopper 32A may be located at the top end of the guide wall 32, or may be excluded from the guide wall 32. In this case, the opening 36 may be located in the lower surface of the arm 30. Thus, the shaft 22 only needs to be configured to allow (a) the rotation of the guide 35 about the shaft 22 and (b) the movement of the shaft 22 along the guide 35, and thereby allow the arm 30 to exit the housing 21.

If the article holding device 10 includes at least one of the first limiter 23B, the upper limiter 38, and the lower limiter 39 in the same way as in the fourth modification, the bend formed at the boundary between the mounting portion 35A and the actuating portion 35B may be excluded from the guide 35.

For example, the mounting portion 35A and the actuating portion 35B may have one linear shape extending in the front-back direction or one arc shape. The opening 36 may be located in the retaining wall 31 so as to be open to an internal surface of the arm 30, such as the second retaining slope 31B.

One of the holder 20 and the arm 30 may be an abutment member, and the article holding device 10 may include an urging unit. The urging unit urges the arm 30 to enter the housing 21. An example of the urging unit is the torsion coil spring 40. The article holding device 10 may include a limiter 39T that is located on the path of the movement of the urging unit relative to the abutment member. The limiter 39T restricts the relative movement of the shaft 22 along the guide 35 within a predetermined range by contact between the urging unit and the limiter 39T. The article holding device 10 may exclude the first limiter 23B, the upper limiter 38, and the lower limiter 39, and may include only the limiter 39T.

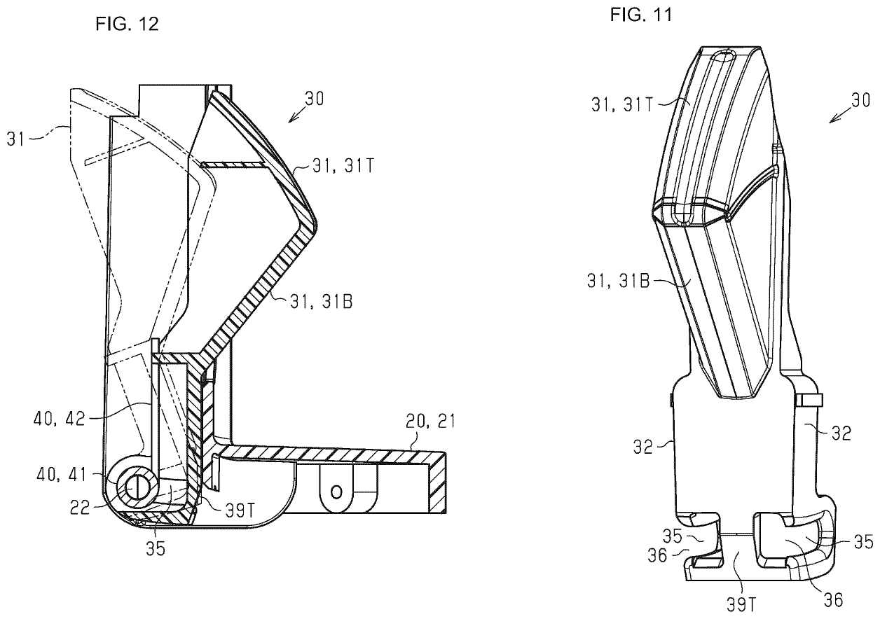

For example, as illustrated in FIG. 11, the guide 35 may have one linear shape without a bend in the same way as in the fourth modification. In other words, the mounting portion 35A and the actuating portion 35B may have one linear shape extending in the front-back direction or one arc shape. The movement of the shaft 22 along the guide 35 may move from the mounting portion 35A to the actuating portion 35B without bending at the boundary between the mounting portion 35A and the actuating portion 35B.

In this case, the opening 36 may be open to the internal surface of the arm 30 so as to allow the shaft 22 to pass backward from the internal surface of the arm 30. The two openings 36 through which the two shafts 22 pass are arranged along the extending direction of the shafts 22. The two openings 36 are partitioned by one limiter 39T. The two openings 36 with the limiter 39T interposed therebetween each allow the shaft 22 to pass from the opening 36 to the guide 35 along the extending direction of the guide 35. The limiter 39T interposed between the two openings 36 restricts the coil 41 attached to the two shafts 22 from moving further toward the front of the FIG. 11 than the limiter 39T. The restriction of movement of the coil 41 by the limiter 39T that contacts the coil 41 restricts such a relative movement of the shaft 22 with the coil 41 attached thereto as to come out of the opening 36 along the guide 35.

As illustrated in FIG. 12, the shaft 22 is located at the lower portion in the upper-lower direction of the support wall 21W, in the same way as in the fifth modification. The guide 35 is located at the lower portion in the upper-lower direction of the guide wall 32. The shaft 22 allows (a) the rotation of the guide 35 about the shaft 22 and (b) the movement of the shaft 22 along the guide 35, and thereby allows the arm 30 to exit the housing 21. If the exit of the arm 30 includes a large amount of translation component of the arm 30, (b) the movement of the shaft 22 along the guide 35 brings the shaft 22 closer to the opening 36 by a large amount as the arm 30 exits.

In this regard, the limiter 39T is located on the path of the movement of the coil 41 relative to the arm 30. The movement of the coil 41 relative to the arm 30 corresponds to the movement of the shaft 22 relative to the guide 35. The limiter 39T restricts the relative movement of the shaft 22 along the guide 35 within a predetermined range by contact between the limiter 39T and the coil 41. This restriction restrains the contact between the limiter 39T and the coil 41 from causing the shaft 22 to depart from the guide 35, even if the guide 35 has a linear shape. As a result, the shaft 22 continues to be held in the guide 35 even if the exit of the arm 30 includes a large amount of translation component of the arm 30.

### Sixth Modification: Guide 35

The holder may include the guide 35, and the arm 30 may include the shaft 22. In this case, the torsion coil spring 40 may be provided one for each of the shafts 22. Even with this configuration, effects similar to (1) to (6) described above are obtained.

### Seventh Modification

The mounting portion 35A may be a bottomed groove that does not penetrate the guide wall 32. The actuating portion 35B may be a bottomed groove that does not penetrate the guide wall 32. Furthermore, the entire guide 35 may be a bottomed groove that does not penetrate the guide wall 32. The guide 35 only needs to include the mounting portion 35A that receives the shaft 22 that requires, when being received by the actuating portion 35B, the actuating portion 35B to be deformed, into the guide 35 by the movement of the arm 30 relative to the holder 20.

For example, the two mounting portions 35A may have a structure in which the distance between the two mounting portions 35A narrows toward the actuating portion 35B in the extending direction of the shaft 22. The opening 36 is a portion where the distance between the two mounting portions 35A is the largest and need not be open at an edge of the arm 30.

### Eighth Modification

The mounting portion 35A may have a curved shape, and the actuating portion 35B may have a linear shape extending in a tangential direction of at the first end 35A1 of the mounting portion 35A.

### Ninth Modification

The mounting portion 35A may be connected to an intermediate location of the actuating portion 35B in the extending direction of the actuating portion 35B. In other words, the connection 35B1 may be located at the intermediate location of the actuating portion 35B in the extending direction of the actuating portion 35B. Even with this configuration, effects similar to (1) to (5) described above are obtained.

### Tenth Modification

The opening 36 may be formed only of the second end 35A2 of the mounting portion 35A. The opening 36 only needs to be long enough to receive the shaft 22 in the extending direction of the shaft 22.

Technical ideas derived from the embodiment and the modifications described above will be noted below.

### Note 1

An article holding device includes:
a holder including a housing that accommodates an article,
an arm that advances to and retreats from the housing so as to hold the article, and
an urging unit that urges the arm to enter the housing, characterized in that
one member of the holder and the arm includes a shaft,
a member other than the one member of the holder and the arm includes a guide,
a relative movement of the shaft along the guide is configured to cause the arm to advance and retreat,
one of the holder and the arm is an abutment member, and
the abutment member includes a limiter that is located on a path of a movement of the urging unit relative to the abutment member, and restricts the relative movement of the shaft along the guide within a predetermined range by contact between the urging unit and the limiter.

According to Note 1 described above, the limiter of the abutment member contacts the urging unit as the urging unit urging the arm toward the housing is displaced along with the movement of the arm. The limiter in contact with the urging unit restricts the displacement of the urging unit with respect to the limiter, which, in turn, restricts the displacement of the shaft with respect to the guide in conjunction with the displacement within the predetermined range. If the guide itself defines the displacement range of the shaft with respect to the guide, the structure of the guide is limited not only so as to allow the movement of the shaft relative to the guide, but also so as to define even the displacement range of the shaft. As a result, it is difficult to employ a structure of the guide suitable for processing the guide or a structure of the guide that reduces the load when attaching the shaft to the guide. In this regard, according to the configuration of Note 1, the contact between the limiter and the urging unit restricts the displacement of the shaft with respect to the guide within the predetermined range. Therefore, the degree of freedom in the design of the guide can be increased.

### Note 2

In the article holding device according to Note 1,
the urging unit is a torsion coil spring that includes a spring arm,
the torsion coil spring includes the spring arm that is hooked on a stop of the arm,
the stop moves the spring arm relative to the shaft by an external force to cause the arm to exit the housing, thereby allowing the shaft to move relative to the guide,
the abutment member is the holder that includes the shaft, and
the limiter is located on a path of a movement of the spring arm relative to the shaft, and restricts a displacement of the spring arm with respect to the shaft within a predetermined range by contact between the spring arm and the limiter.

According to Note 2 described above, as illustrated in the example of the first limiter 23B, the movement of the spring arm is restricted by the limiter. Therefore, the movement of the shaft relative to the guide is restrained within the predetermined range.

### Note 3

In the article holding device according to Note 1 or 2,
the urging unit is a torsion coil spring that includes a coil attached to the shaft,
the abutment member is the arm that includes the guide,
the limiter is located on a path of a movement of the coil relative to the guide, and restricts a displacement of the coil with respect to the guide within a predetermined range by contact between the coil and the limiter.

According to Note 3 described above, as illustrated in the examples of the upper limiter 38 and the lower limiter 39, the movement of the coil is restricted by the limiter. Therefore, the movement of the shaft relative to the guide is restrained within the predetermined range.

1. An article holding device comprising:
a holder provided with a housing configured to accommodate an article; and
an arm configured to enter the housing so as to hold the article and configured to exit the housing, wherein
one of the holder and the arm is provided with a shaft,
another of the holder and the arm is provided with a guide,
the guide is provided with an actuating portion, and a mounting portion that continues to the actuating portion and is bent toward the actuating portion,
the arm enters the housing or exits the housing when the shaft moves relative to the actuating portion along the actuating portion, and
the shaft moves so as to bend toward the actuating portion after moving along the mounting portion so that the actuating portion is received from the mounting portion.

2. The article holding device according to claim 1, wherein
the mounting portion is provided with a first end and a second end,
the first end continues to the actuating portion, and
the second end forms an opening to receive the shaft into the guide.

3. The article holding device according to claim 1, further comprising an urging unit configured to urge the arm to enter the housing, wherein
the urging unit is a torsion coil spring attached to the shaft.

4. The article holding device according to claim 3, wherein
the torsion coil spring is provided with a spring arm,
the arm is provided with a stop configured to hook the spring arm,
the stop pushes the spring arm so that the spring arm relatively moves to the shaft and the shaft relatively moves to the actuating portion when an external force acts on the arm so as to cause the arm to exit the housing, and
the holder includes a first limiter configured to restrict a displacement of the spring arm with respect to the shaft on a path of a relative movement of the spring arm relative to the shaft.

5. The article holding device according to claim 4, wherein
the actuating portion includes a connection that continues to the mounting portion, and
the first limiter is located on the path so as to locate the connection out of a range of the relative movement of the shaft in the actuating portion.

6. The article holding device according to claim 3, wherein
the torsion coil spring includes a coil in which the shaft is inserted, and
the arm includes a second limiter configured to restrict a displacement of the coil with respect to the arm on a path of a relative movement of the coil relative to the arm.

7. The article holding device according to claim 6, wherein
the actuating portion includes a connection that continues to the mounting portion, and
the second limiter is located on the path so as to locate the connection out of a range of the relative movement of the shaft in the actuating portion.

8. The article holding device according to claim 1, further comprising an urging unit configured to urge the arm to enter the housing, wherein
the actuating portion includes a connection that continues to the mounting portion, and
the urging unit is configured to urge the arm so as to move the shaft away from the connection in the actuating portion.

9. An article holding device comprising:
a holder provided with a housing configured to accommodate an article;
an arm configured to enter the housing so as to hold the article and configured to exit the housing; and
an urging unit configured to urge the arm to enter the housing, wherein
one of the holder and the arm is provided with a shaft,
another of the holder and the arm is provided with a guide,
the guide is provided with an opening configured to receive the shaft,
the arm enters the housing or exits the housing when the shaft moves relative to the guide along the guide,
one of the holder and the arm is an abutment member,
the abutment member is provided with a limiter,
the limiter is located on a path of a relative movement of the urging unit relative to the abutment member, and
the limiter is configured to restrict a displacement of the shaft moving out of the opening by contacting the urging unit even if the urging unit is displaced with respect to the abutment member.
